(19) United States
(12) Patent Application Publication
(10) Pub. No.: US 2010/0250396 A1
(43) Pub. Date: Sep. 30, 2010

(54) POPULATING A SERVICE REGISTRY WITH WEB CONTENT

(76) Inventors: Mehmet Kivanc Ozonat, Mountain View, CA (US); Sven Graupner, Mountain View, CA (US); Sujoy Basu, Sunnyvale, CA (US); Donald E. Young, Portland, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/409,550

(22) Filed: Mar. 24, 2009

(51) Int. Cl. G06Q 30/00; G06F 17/30; G06N 5/02; G06F 15/18

(52) U.S. Cl. 705/27; 706/54; 706/12; 707/E17.108

(57) ABSTRACT

One embodiment is a method that receives a list of service providers offering services at web sites and extracts content from the web sites to identify the services offered by the service providers. The method then populates service registries with the content.

### CROSS-REFERENCE TO RELATED APPLICATIONS

This application relates to the following patent applications which are filed concurrently herewith and incorporated herein by reference: attorney docket number 200802997-1 entitled “Transforming a Description of Services for Web Services” and attorney docket number 200802991-1 entitled “Building a Standardized Web Form.”

### BACKGROUND

Service providers are businesses that provide subscription or web services to other businesses and individuals. Typically, service providers have a presence on the World Wide Web (web) through which they describe and offer their services. Users can navigate through web pages to obtain information about services being offered.

Web services can be complex and include, for example, multiple service properties and various costs and options. To alleviate this complexity, web pages often describe available services in an informal manner that is easily readable and understandable to users visiting the web page.

Although users can understand the web pages, informal and unstructured descriptions of services are difficult for a computer to understand. For example, such language cannot be easily used by programs for service selection.

### BRIEF DESCRIPTION OF THE DRAWINGS

FIG. 1 is a flow diagram of a method for retrieving web content of service providers in accordance with an exemplary embodiment of the present invention.

FIG. 2 is a system to extract service properties from web content and classify service providers and services in accordance with an exemplary embodiment of the present invention.

FIG. 3 is a general method to extract service properties from web content, classify service providers and services, and process a query for a service registry in accordance with an exemplary embodiment of the present invention.

FIG. 4 is a detailed method to extract service properties from web content and classify service providers and services in accordance with an exemplary embodiment of the present invention.

FIG. 5 is a computer system for implementing methods in accordance with an exemplary embodiment of the present invention.

### DETAILED DESCRIPTION

Exemplary embodiments in accordance with the invention include apparatus, systems, and methods that classify service providers and extract service properties from web content.

One embodiment uses a text classification technique that extracts significant words from web content of a service provider. Based on these extracted words, the services are categorized into a group of known businesses or business categories, such as subscription services, web hosting services, printing services, etc. Typical properties associated with the group are then extracted and stored. In printing services for example, this extraction could include printing properties, such as a number of copies, paper format for printing services, color, resolution, etc.

Once the services are extracted and categorized, exemplary embodiments use this information for a variety of tasks. By way of example, service providers are classified into known service categories, and this categorization enables, for instance, automated creation of registries or indexes of services available on the web. Furthermore, exemplary embodiments enable identifying service properties from web content for service categories. This information is used to automatically populate a service registry with structured information about service providers found on the web. Users and enterprises use these registries to locate available services, compare costs of different service providers, compare services of different service providers, etc. For example, a user can query and search the registries to locate service providers and determine information about the service providers, such as available services, options, prices, etc.

Additional usage for the categorized information also exists. By way of example, exemplary embodiments can be applied where unstructured descriptions (documents) are required to be classified and properties are required to be extracted from the descriptions. In other words, exemplary embodiments are applicable where structured information needs to be extracted from unstructured content. Examples include automatically selecting and engaging with services on the web through agents or other processing systems. For example, consider a service registry that has structured information on each service, such as structured fields of Company Name, Price, URL, Description, Terms of Use, Audience, etc. This registry is more easily populated with exemplary embodiments that automatically extract such information from the web pages of a service. The web pages are unstructured, but the registry is structured using the structured fields. The Price field can be populated by categorizing the service as free, flat fee, per-user charge, etc. The Audience field can be populated by categorizing the service as being targeted to Consumers, Developers, or Small and Medium Businesses. Hence the process is converting unstructured information that appears on web sites to structured information, such as organized information with pre-defined categories in a service registry.

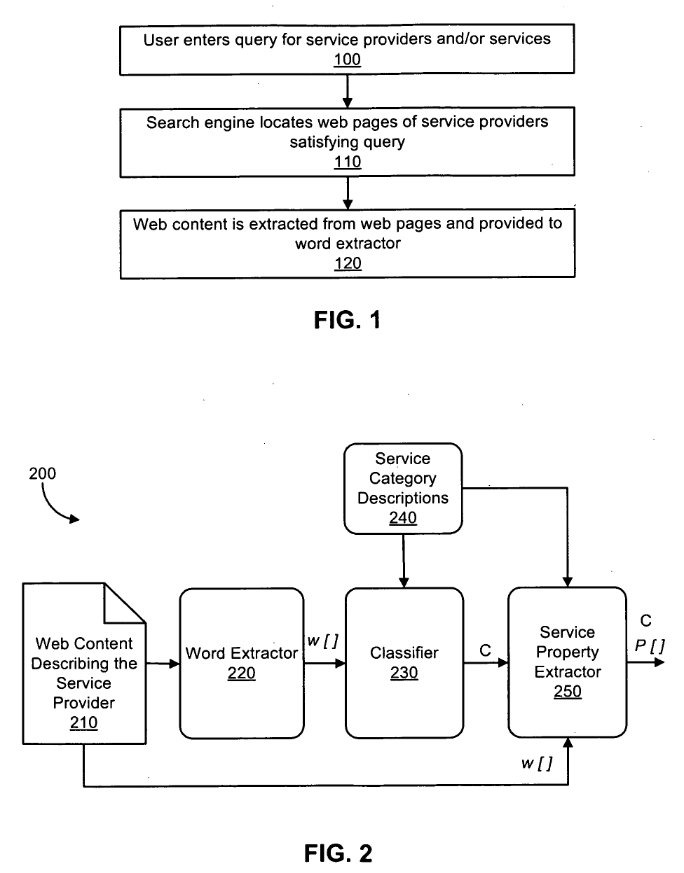

FIG. 1 is a flow diagram of a method for retrieving web content of service providers in accordance with an exemplary embodiment of the present invention.

According to block 100, a user enters a query to discover service providers and/or services offered by service providers. By way of example, a user enters keywords into a search engine, such as GOOGLE, ALTA VISTA, etc. The keyword can include a description of services desired offered by a specific type of service providers, such as printing services, web hosting service, sales and marketing services, lead generation services, technical support services, etc.

In one embodiment, a search engine discovers a list or pool of service providers through which a customer can engage in a business interaction over the web to meet its service needs. By way of illustration, exemplary phrases include “telemarketing service,” “printing service,” or “web hosting service,” as input to retrieve the list of service providers and their web pages.

According to block 110, a search engine locates web pages, web sites, and web content of the service providers and services satisfying the query. The search engine discovers web pages that meet the search criteria entered by the user. For example, if the user entered “printing service” the search engine returns a list of web pages of service providers that offer printing services.

According to block 120, the web pages, web sites, and web content are provided to a word extractor. The list of search results are sent or transmitted to the word extractor.

Since links returned from search can refer to other links and content that may or may not be service providers. One exemplary embodiment follows discovered hyperlinks and assesses content obtained from the hyperlinks in order to determine whether or not content represents a service provider. If content could be successfully probed and classified as representing a service provider, the service provider is added to the pool of potential service provider candidates.

In order to determine whether or not a returned link represents a service provider, one exemplary embodiment examines forms or questionnaires provided at the web sites. The approach here is to search or look for form pages or web forms that encourage users to engage with the service or request information from users about a desired service. This step results in a pool of potential service provider candidates.

Furthermore, in preparation of a comparison, service properties are identified for candidates from their web content. The approach here relies on meta-tags and content of online service engagement forms. Thus, this step also provides a set of service properties identified for each service. The service candidates are ready for comparison after their service properties are extracted.

FIG. 2 is a computer system 200 to extract service properties from web content and classify service providers and services in accordance with an exemplary embodiment of the present invention. For example, the system extracts service properties from the web pages and web sites discovered in block 120 of FIG. 1.

The system 200 classifies service providers into known service categories that enable, for instance, automated creation of registries of services from the web. Furthermore, the system also provides identification of service properties from web content for service categories. This information is used to automatically populate a service registry with structured information about service providers found on the web.

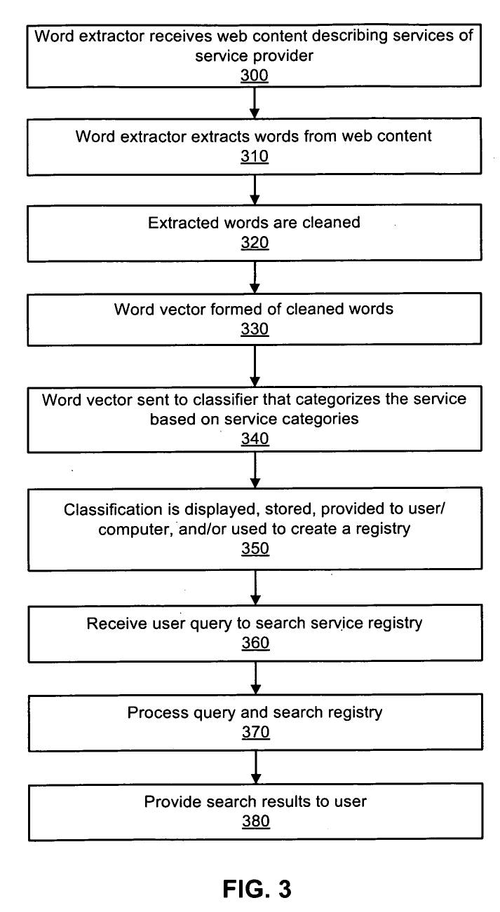

FIG. 3 is a general method to extract service properties from web content, classify service providers and services, and process a query for a service registry in accordance with an exemplary embodiment of the present invention. FIGS. 2 and 3 are discussed together.

According to block 300, a word extractor 220 receives web content 210 describing the service provider. As discussed above in block 120 of FIG. 1, the web pages, web sites, and web content are provided to the word extractor 220.

According to block 310, the word extractor 220 extracts words from the web content. The extracted words relate to one or more services being offered by the service provider. For example, if the initial query were for printing services, then the word extractor would extract words relating to a service provider that provides printing services for customers.

Then according to block 320, the extracted words are cleaned. The word extractor 220 extracts words from the web content 210 and cleans the content from format coding and other disturbances. At the same time, structural properties are retained as if they were in a web form, such as title, meta tag, etc.

According to block 330, a word vector is formed of cleaned words. For example, a list of terms with their properties is represented as a word vector w[ ].

According to block 340, the word vector is sent to a classifier 230 that categorizes the services based on service categories. The classifier component 230 applies a statistical learning technique to categorize the services based on a set of pre-established service categories, which are described by the service category descriptions 240. Generation of the service category descriptions 240 can be enhanced by using third party existing categorizations such as HOOVERS online business registry or carrier identification codes (CIC codes) provided by North America Numbering Plan Administration (NANPA). The result is a category C to which the service belongs.

The service property extractor 250 determines a set of properties that are typically associated with services of the corresponding category. The web document is then investigated for the presence of those properties. If such properties exist, then they are extracted and added to the property vector P[ ].

According to block 350, the result is displayed, stored, provided to a user or computer, and/or used to create a registry. For example, the information obtained about the service providers and services being offered is used to modify, transform, augment, or create a registry.

According to block 360, a query is received from a user to search the service registry. A user enters a query to discover services offered by a service provider. For example, a user can enter a query to determine which service providers offer printing services.

According to block 370, the query is processed and the registry is searched based on the query received from the user.

According to block 380, the search results are returned to the user. The search results provide the user with information about service providers offering the desired (i.e., queried) services. For example, the information informs the user about which service providers provide printing services. Such information can include, but is not limited to, information about the service providers, such as one or more of name, website (such as link to website or URL), address and contact details, types of services offered, description of services offered, options for services, prices for offered services, etc. This information can be provided to the user, such as being displayed and/or transmitted to the user.

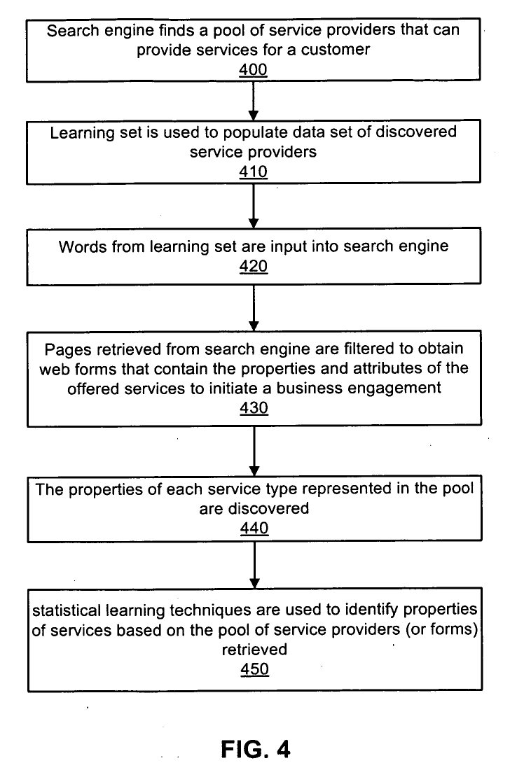

FIG. 4 is a detailed method to extract service properties from web content and classify service providers and services in accordance with an exemplary embodiment of the present invention. FIG. 4 illustrates an example where a user enters phrases or terms (telemarketing service, printing service, and copyright service litigation) as input to retrieve web pages for the corresponding service providers.

According to block 400, a search engine finds a list or pool of service providers through which a customer can engage in a business interaction over the web to meets service needs.

According to block 410, in order to populate the data set (of service providers), words are randomly selected from a learning set (such as WIKIPEDIA) of descriptions of the three services (telemarketing, printing, and copyright litigation).

According to block 420, the words from the learning set are then input to a search engine, such as a GOOGLE or ALTA VISTA search.

According to block 430, the pages retrieved by the search engine are filtered to only identify web forms that contain the properties and attributes of the offered services to initiate a business engagement. Thus, for each retrieved web page by the search engine, the HTML source of the web page is retrieved to filter the non-form pages (or non-form sections of the form pages). Standard HTML tags are used that denote HTML form tags. In order to identify service properties of service candidates, a pool of forms is collected.

According to block 430, once the pool of service providers (or, alternatively, the pool of forms, since there is a one-to-one mapping between forms and service providers) is determined, the properties of each service type represented in the pool are discovered.

For illustration, the following designations are provided: each service type is denoted by m; each service provider (or form) is denoted by n; and each word used in the forms is denoted by w. Additionally, the number of service types, number of service providers, and the number of distinct words used in the forms are denoted by M, N and W, respectively. The parameters N and W are predetermined since the pool of forms is already discovered. An assumption is made that the service types m (and consequently the number of service types M) are known.

According to block 440, statistical learning techniques are used to identify properties of services based on the pool of service providers (or forms) retrieved by the methods described above. One exemplary embodiment uses both supervised and unsupervised learning techniques. In supervised learning, the service type of each service provider n is assumed to be known, while in unsupervised learning this information is missing.

The following data representations are used. Each service provider (or form) n is modeled by a sequence of W bits (sequence of 0's and 1's), where each bit represents whether a word is present in the form. If the bit is 0, the word is absent; and if the bit is 1, the word is present.

For unsupervised learning, clustering is an unsupervised learning technique, where objects that are close under some distortion criterion are clustered in the same group. For supervised learning, when the cluster labels of the objects are already available (i.e., the service type of each service provider is known), one can use a supervised learning technique. The data is modeled as a mixture of M (where M=3) W-dimensional Gaussians, and estimated the parameters each Gaussian using the sample averages of the forms in that cluster. By way of example a k-means clustering algorithm is used for supervised classification with the squared-error distortion measure to cluster forms into M=3 groups.

Each object to be clustered is a vector of 0's and 1's of length W with the vector representing a form.

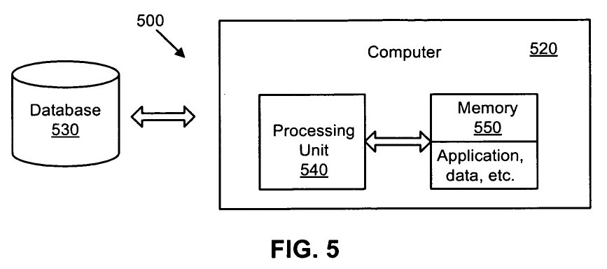

FIG. 5 is a computer system 500 for implementing methods in accordance with an exemplary embodiment of the present invention. The computer system, for example, can include the embodiment discussed in connection with FIG. 2.

The computer system 500 includes a computer 520 coupled to storage devices 530, such as a database. The computer 520 comprises a processing unit 540 (such as one or more processors of central processing units, CPUs) for controlling the overall operation of memory 550 (such as random access memory (RAM) for temporary data storage and read only memory (ROM) for permanent data storage) and one or more algorithms or programs (such as algorithms and/or programs to implement methods in accordance with exemplary embodiments). The memory 550 stores data, control programs, and other data associate with the computer 520.

Embodiments in accordance with the present invention are not limited to any particular type or number of storage devices and/or computer. The computer system, for example, includes various portable and non-portable computers and/or electronic devices. Exemplary computer include, but are not limited to, servers, main frame computers, distributed computing devices, laptops, and other electronic devices and systems whether such devices and systems are portable or non-portable.

### DEFINITIONS

As used herein and in the claims, the following words are defined as follows:

The term “classifier” is a software component that reads a vector of words extracted from an input web document and computes a classification of service properties of the web document for a service category.

The term “registry” means a listing of web service providers that provide services to individuals and entities. The registry includes information about the service providers, such as one or more of name, website (such as link to website or URL), address and contact details, types of services offered, description of services offered, options for services, prices for offered services, etc. The registry provides a source of reference and information when reviewing or selecting service providers.

The term “service category descriptions” is a data structure that represents a set of training data of service properties for service categories for the classifier.

The term “service property extractor” is a software component that extracts the service property set from the classification and transforms it into two outputs: the service category C and the set of service properties for this service category P[ ].

A “user” or “requestor” or “customer” is human, entity, machine, computer, or program. In some embodiments, they request, describe, and define the service requirements and ultimately select the service provider.

The term “web document” is a Hypertext Markup Language (HTML) page that is accessible over Hypertext Transfer Protocol (HTTP) protocol.

The term “web form” is a form on a web page that allows a user to enter data that is sent to a server for processing. Web forms resemble paper forms and enable internet users the ability to electronically fill out the forms using, for example, checkboxes, radio buttons, menus, etc. Web forms are used to enter information (such as personal information and product and service request information) to enable the service provider to perform the requested service.

The term “word extractor” is a software component that reads a web document (such as a web page) as input and extracts words (as text) from the document.

In one exemplary embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
extracting web content from web sites of service providers;
populating, with a computer, service registries with the web content; and
processing, with the computer, a query from a user to search the service registries and retrieve information about services offered by the service providers.

2) The method of claim 1 further comprising, using the web content to categorize services offered by the service providers into one of plural business categories.

3) The method of claim 1 further comprising, discovering the service providers with a search engine.

4) The method of claim 1 further comprising:
querying the service registries to compare costs and services offered by different service providers;
displaying a comparison of the costs and services to the user.

5) The method of claim 1 further comprising, following hyperlinks to linked websites to determine if the linked websites offer services of a service provider.

6) A computer, comprising:
a processor that extracts words from web content of a service provider, uses the words to categorize services offered by the service provider into one of plural business categories, and populates a service registry with information extracted from the web content.

7) The computer of claim 6, further comprising a word extractor that extracts the words from the web content, wherein the extracted words relate to services offered by the service provider.

8) The computer of claim 6, further comprising a service property extractor that determines a set of properties associated with services offered by the service provider and adds the set of properties to a property vector used to populate the service registry.

9) The computer of claim 6, further comprising a classifier that categorizes the services offered by the service provider into one of plural business categories

10) The computer of claim 6, wherein the plural business categories include web hosting, subscription services, and printing services.

11) The computer of claim 6, wherein a statistical learning technique is used to categorize the services based on a set of pre-established service categories.

12) The computer of claim 6, wherein the processor further determines if a web site offers web services by searching for web forms that relate to services being offered by a service provider.

13) The computer of claim 6, wherein the processor further receives a query from a user, searches the service registry, and extracts information about service providers that offer services described in the query.

14) A tangible computer readable storage medium having instructions for causing a computer to execute a method, comprising:
receiving a list of service providers that offers services at web sites;
extracting content from the web sites to identify the services offered by the service providers; and
populating service registries with the content.

15) The tangible computer readable storage medium of claim 14 further comprising, processing a query from a user to search the service registries and retrieve information about services offered by the service providers.

16) The tangible computer-readable storage medium of claim 14 further comprising, using both supervised and unsupervised statistical learning techniques to identify properties of services being offered by the service providers.

17) The tangible computer readable storage medium of claim 14 further comprising, determining if a web site offers web services by searching for web forms that relate to services being offered by a service provider.

18) The tangible computer readable storage medium of claim 14, wherein the list of service providers is received from a search engine that searches the web for service providers offering services according to an initial query.
